(19) United States
(12) Patent Application Publication
(10) Pub. No.: US 2004/0111529 A1
(43) Pub. Date: Jun. 10, 2004

(54) Dynamic host based load balancing of a multihomed network

(75) Inventor: Pankaj Parmar, Beaverton, OR (US)

Correspondence Address: MARGER JOHNSON & McCOLLOM, P.C., 1030 S.W. Morrison Street, Portland, OR, 97205, US

(73) Assignee: Intel Corporation (a Delaware corporation), Santa Clara, CA (US)

(21) Appl. No.: 10/317,079

(22) Filed: Dec. 10, 2002

(51) Int. Cl. G06F 15/16

(52) U.S. Cl. 709/245

(57) ABSTRACT

A multihomed network distributes load information associated with different source address prefixes. A host dynamically balances the network load by directing global network traffic according to the load information. Load information may be delivered to the host using existing communication mechanisms, such as the neighbor discovery messages.

### TECHNICAL FIELD

The present invention relates to multihomed networks.

### BACKGROUND AND RELATED ART

With more computers and devices using the Internet Protocol (IP), there is a growing need for a simpler and more flexible hierarchy that reduces overhead associated with IP network traffic and still provides the necessary IP address space for the future. In an attempt to satisfy recent concerns over the impending depletion of the current pool of Internet addresses and the desire to provide additional functionality for Internet devices, the Internet Engineering Task Force (IETF) has developed IP version 6 (IPv6).

One of the more significant changes of IPv6 over the previous IP version (IPv4) involves the larger addressing space. More specifically, IPv6 uses 128-bit source and destination addresses compared with the 32-bit addresses used by IPv4. The use of 128-bit addressing allows for multiple levels of hierarchy and more flexibility in designing hierarchical addressing and routing schemes than is currently available in the IPv4 addressing scheme. Networks using IPv6 nodes contain various hierarchical layers of addresses that are used to manage the network, such as aggregatable global unicast addresses, link-local unicast addresses, site-local unicast addresses, and multicast addresses.

The hierarchical layers provided by IPv6 may change the way multihoming devices within a network are perceived. In IPv4, multihoming is generally perceived as a host or system that uses multiple network interfaces. In contrast, hosts in IPv6 may only have one network interface, but respond to multiple global IPv6 addresses, link-local addresses, and site-local addresses. As a result, almost every host in the IPv6 network can be a multihomed host.

Another type of multihoming affected by the introduction of IPv6 is site multihoming, where an enterprise domain or site-local domain has multiple global communication channels with more than one Internet Service Provider (ISP). In this configuration, a host could use more than one global address. For instance, each global communication channel could be associated with a different global address. Data packets that are destined for hosts located outside of the enterprise domain are routed via one or more site exit routers to one of the global communication channels.

Intra domain routing compares the packet source address with a prefix, or a set of prefixes, associated with each exit router to make sure that all global packets will pass the ingress filtering checks done at an external ISP router. Packets that do not match are dropped either with or without notification to the host or get forwarded to the correct exit router. Ingress filtering is a mechanism that an ISP adopts to ensure the received packets do not contain spoofed source addresses. The ISP routers enforcing ingress filtering often use reverse-path-forwarding checks to determine if packets are authentic. The packet is dropped if the source address prefix does not match the prefix advertised on that interface. Thus packets can only leave the domain via a specific site exit router associated with the selected source address, otherwise the packets could be dropped.

Typically, host applications do not explicitly select the source address. Rather, the underlying IP stack selects one source address for the host application. In IPv6, the IP stack looks at the destination address and then determines the source address. If the host has multiple global communication channels to select from, the IPv6 stack typically selects a default source address, such as the first address in a list or the address for a preferred router. Consequently all packets from a multihomed IPv6 host are usually routed to the same default ISP. This leads to over utilization or loading of one ISP connection and underutilization of other available ISP connections.

### BRIEF DESCRIPTION OF THE DRAWINGS

FIG. 1 illustrates an embodiment of an operating environment for a dynamic load balancing system;

FIG. 2 illustrates one embodiment of the dynamic load balancing system in more detail;

FIG. 3a & FIG. 3b illustrate block diagrams of data packets used in one embodiment for delivering load information;

FIGS. 4A and 4B are flow charts showing an embodiment of how source addresses are selected according to received load information;

FIG. 5 is a flow chart showing one embodiment of how priority values are assigned to source address prefixes; and

FIG. 6 is a flow chart showing one embodiment of how load information is transmitted.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

Reference in the specification to “one embodiment” or “an embodiment” means that a particular feature, structure, or characteristic described in connection with the embodiment is included in at least one aspect of the invention. The appearances of the phrase “in one embodiment” in various places in the specification do not necessarily all refer to the same embodiment.

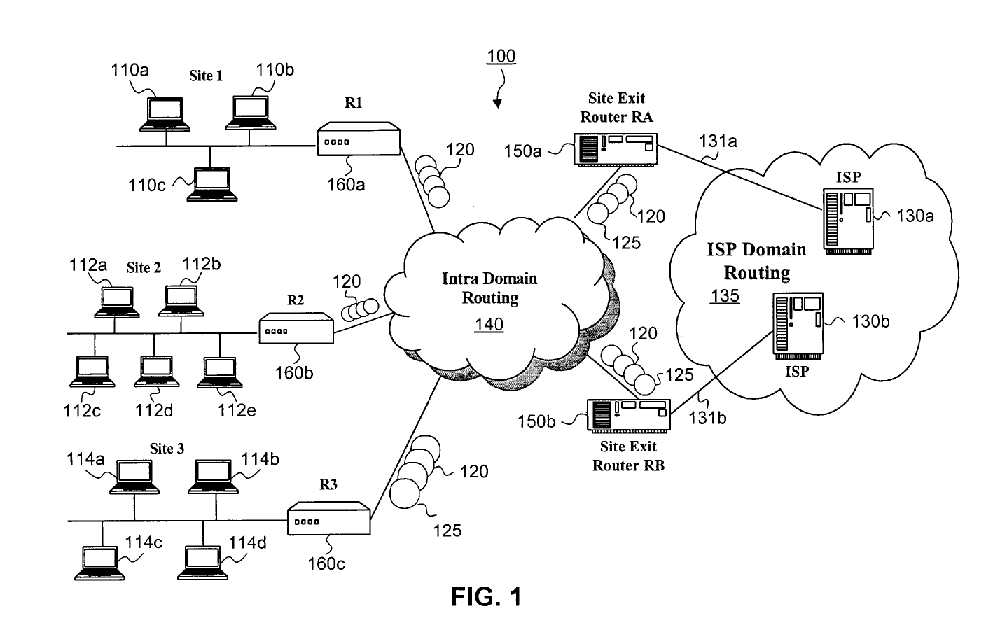

FIG. 1 shows a network environment 100 that provides a dynamic load balancing scheme for networks, such as a multihomed IPv6 network. The network environment 100 includes a plurality of hosts 110a-110c, 112a-112e, and 114a-114d each exchanging data 120 over Internet Service Providers (ISP) domain routing 135 and intra domain routing 140. The intra domain routing 140 include exit routers, or exit gateway devices 150, that provide global communication channels 131 to ISPs 130.

Other embodiments of network 100 may also include other types of network processing devices including network switches, routers, hubs, multiprocessor systems, programmable or configurable consumer electronics, minicomputers, mainframe computers, personal computer systems and other systems.

Some of the data 120 contains messages 125 that may include one of more source address prefixes and associated load information. The messages 125 are sent from the exit routers 150 to the hosts 110, 112, and 114. Load information refers to data characterizing loading for different network processing devices. In one embodiment, the messages 125 include multiple preexisting fields. One or more of these preexisting fields is used for identifying the source address prefix. Another preexisting field is used for identifying the loading information.

Exemplary loading information may include current router bandwidth usage, number of incoming or outgoing network connections, type of sessions, number of open connections, Central Processing Unit (CPU) utilization, and any other types of router loading characteristics. How this loading information is derived is known to those skilled in the art, and is therefore not explained in further detail.

In an IPv6 network, hosts 110-114 will have a link local address, a site local address and various global addresses. The link-local address is typically used for communicating with devices directly connected to the host, such as printers, network interface cards, peripheral devices, and other local hosts. The site-local address is typically used to communicate with devices that are connected to the same local network, such as all devices connected to the same router 160.

The hosts 110-114 can be organized into local links and local site hierarchies according to their addresses. Each local link or local site may contain several host devices and a router. For example, Site 1 includes hosts 110a-110c and router 160a. Site 2 includes hosts 112a-112e and router 160b. Site 3 includes hosts 114a-114d and router 160c. An enterprise domain may consist of several sites, such as sites 1-3, interconnected via the intra domain routing 140.

Global addresses are used for communication outside of the enterprise domain and are derived from source address prefixes advertised by ISP 130a and ISP 130b through the site exit routers 150. The advertised source address prefixes allow the routers 160 to route global data 120 towards the correct exit router 150A or 150B. The exit routers 150 connect hosts 110-114 to the ISP domain 135. Data 120 destined to a global host outside of the network environment 100 is routed to one of the site exit routers 150 via intra domain routing 140 and to the global host via the ISP domain routing 135. In one embodiment, the site exit routers 150 may each connect to multiple ISP connections 131.

Site multihoming provides the network environment 100 with fault-tolerance, redundancy and load balancing. For example, when the connection 131a with ISP 130a goes down, traffic may be redirected to connection 131b. Load balancing allows the ISP connections 131a and 131b in the multihomed network to carry an assigned portion of the Internet-related traffic. For example, one form of load balancing could be achieved in the network environment 100 if the ISP 130a is used for inbound traffic and the ISP 130b is used for outbound traffic.

One method of equalizing the load sent to the ISPs 130 is through intelligent source address selection. For example, while communicating with another host on the same link, a host may select the link-local address as the source address and not the site-local or global address. In order to communicate with hosts outside the domain, hosts can use global addresses. Selection of the source global address determines which exit router 150A or 150B is used to transmit data 120 to the ISPs 130.

As previously mentioned, in an IPv6 network, global addresses are derived from source address prefixes advertised by the ISP domain 135 to the connected exit routers 150. In a multihomed networking environment 100, a host 110-114 could have more than one global address. Each global source address is derived from a source address prefix provided by a different ISP 130. In these cases, the standard IPv6 stack in the host looks at the destination address and then selects one of the global source addresses. If a host has multiple global source addresses to select from, the IPv6 stack in the host typically selects a default address, such as the first one in a source address list. Consequently, packets may get routed to the same ISP 130 leading to over utilization or loading of one ISP and underutilization of other available ISPs.

To avoid this situation, the IP stack may be prioritized according to the load information associated with the source address prefixes. Alternatively, the source address prefix selection can be performed by other applications running on the host.

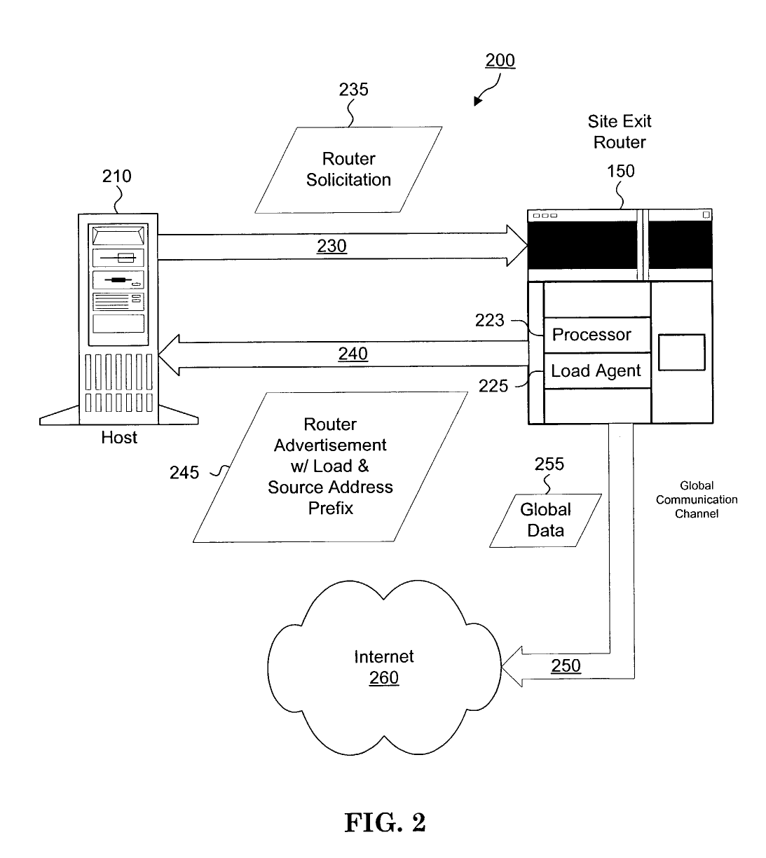

FIG. 2 illustrates in more detail the dynamic load balancing system 200 that includes a host 210 in communication with site exit router 150 through communication channels 230 and 240. The site exit router 150 acquires loading conditions for itself and possibly other network processing devices. The site exit router 150 includes a processor 223, load agent 225, and a global communication channel 250 coupled to Internet 260.

In one embodiment using IPv6, the load information is periodically transmitted to the host 210 in the form of a router advertisement message 245. The host 210 receives the router advertisement messages 245 that include source address prefixes and associated load information. The host 210 updates a local table that may contain a list of other source address prefixes and associated load information. The host refers to the prefix table when sending data.

The site exit router 150 sends router advertisement messages 245 either periodically or in response to the receipt of a router solicitation message 235. The router advertisement message 245 can be periodically sent to multiple hosts at the same time using a multicast address. The site exit router 150 generally responds to the router solicitation message 235 using a unicast router advertisement message 245 sent to the unicast IPv6 address of the host that sent the router solicitation message 235.

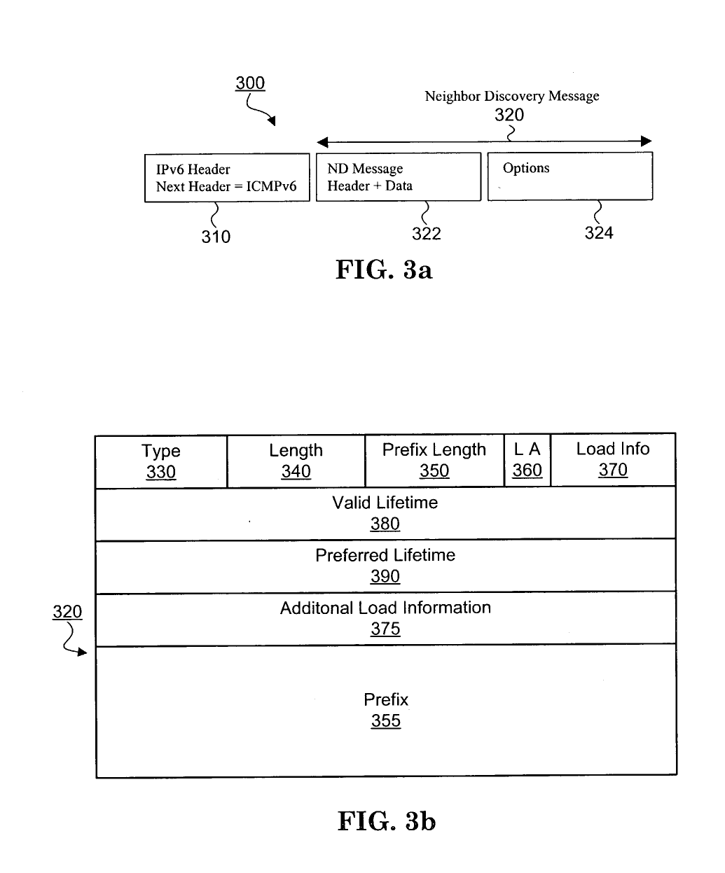

FIG. 3a is a block diagram of one embodiment of an IPv6 neighbor discovery packet 300. Each neighbor discovery packet 300 includes an IPv6 header 310 and a neighbor discovery message 320. The neighbor discovery protocol uses Internet Control Message Protocol for IPv6 (ICMPv6) messages to manage the interaction of neighboring hosts or nodes on the same link. The neighbor discovery protocol is a mechanism, through which hosts may discover their addresses, address prefixes, default router, and other configuration parameters.

The neighbor discovery mechanism allows hosts to query network nodes for configuration information or allows routers to advertise their presence to hosts. In order to establish the neighbor discovery functionality, hosts and routers exchange a set of ICMPv6 messages or neighbor discovery messages 320. The neighbor discovery packet 300 includes the IPv6 header 310, message specific data 322 and a set of message options 324. The message specific data 322 includes the neighbor discovery header, which is typically an ICMPv6 header, and message data.

Different types of neighbor discovery messages 320 include router solicitation 235 (FIG. 2), router advertisement 245 (FIG. 2), neighbor solicitation, neighbor advertisement and redirect messages. In other embodiments, the discovery information can be part of a broadcast-based Address Resolution Protocol (ARP), ICMPv4 router discovery, or ICMPv4 redirect messages. Discovery information can also be sent as part of a multicast message sent using a multicast address. With the appropriate routing topology, the multicast message is delivered to all the interfaces that are identified by the multicast address.

FIG. 3b is a block diagram of an exemplary neighbor discovery message 320. The discovery message 320 includes a type field 330, a length field 340, a prefix length field 350, a prefix information options field 355, a configuration flag field 360, reserved fields 370 and 375, a valid router lifetime field 380, and a preferred reachable lifetime field 390.

The neighbor discovery message 320 includes a prefix information options field 355 that contains the source address prefixes that are used for address autoconfiguration. The host derives a site-local address and/or a global address from the information in prefix field 355 advertised by the exit routers 150 (FIG. 1) or network processing device 220 (FIG. 2).

Load information is incorporated into the neighbor discovery message 320. In one embodiment, load status is indicated using the reserved bits in the reserved field 370. In a two bit configuration, the load information could be indicated as follows:

| Preliminary Indicator Bits | Load State Interpretation |
|---|---|
| 00 | No Load Information |
| 01 | Light Load |
| 10 | Medium Load |
| 11 | Heavy Load |

In one example, load agent 225 in the site exit router 150 (FIG. 2) determines that a “light load” state occurs when the loading information has less than a first range. A “medium load” state is reported when the load information is below a second higher loading range and a “heavy load” state is reported whenever the load information is above the second loading range. The loading ranges could represent any combination of bandwidth usage, connection quality, number of available connections, number of active connections, number of active sessions, session types, and CPU utilization.

Each parameter could be weighted according to its relative effect on the overall router's performance. For example, the light load state could be reported when the exit router or ISP server is operating at less than about 20% bandwidth usage. The medium load state could be reported when the device 220 is operating between about 20% and about 50% bandwidth usage. While the heavy load state could be reported when the device is operating with more than about 50% bandwidth usage.

Upon receiving the router advertisement message 320, the host stores the source address prefix in field 355 and the load information in field 370 in a prefix table. Some of the source address prefixes in the table may also have associated load information. The source address prefixes are prioritized according to their associated load information. A source address prefix having load information indicating a light load may be given higher priority than source address prefixes associated with medium or heavy loads. In one example, source address prefixes that do not have associated load information are given lower priority than devices that are associated with medium or heavy loads. Another embodiment assigns a heavy load state to source address prefixes that have no associated load information.

Additional load information can also be sent using other bits in the prefix information options field 355. The additional load information can reflect the load status for network devices other than the site exit router. For example, load information could be sent to the site exit router from ISP routers, switches, network access servers, hubs, etc. The site exit router then operates as a central load collection and distribution point that sends collected load information to hosts. Each network processing device sending load information to the site exit router may have a different optimal performance range for each of the various loading parameters or characteristics. As such, the previously described range of loading information may be customized for each device to more accurately identify the device's load status.

FIGS. 3A and 3B only illustrate one type of neighbor discovery packet 300. Several other data configurations are acceptable. For example, the neighbor discovery packets 300 do not necessarily have to be associated with a router advertisement or router solicitation message.

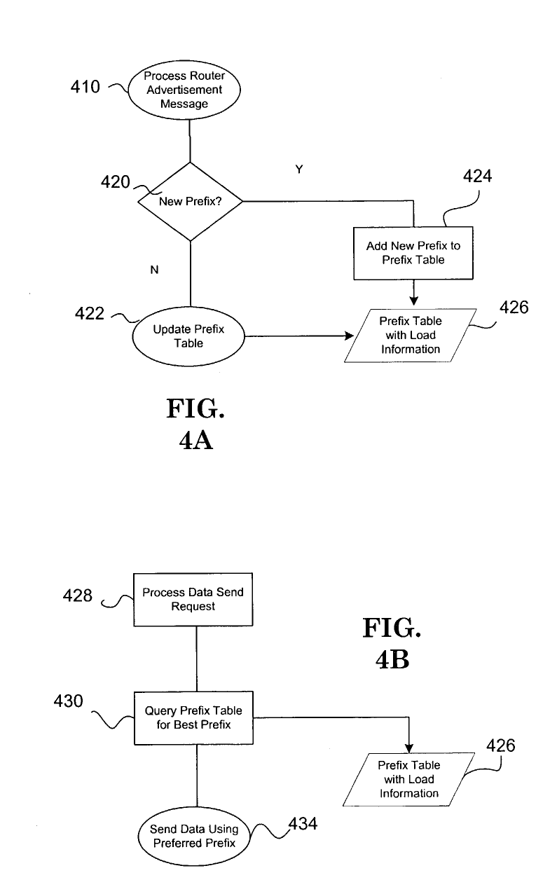

FIGS. 4-6 show particular methods for performing dynamic load balancing using computer software or hardware. The methods to be performed by a network device constitute digital logic or computer programs made up of computer-executable instructions. Describing the methods by reference to a flowchart enables one skilled in the art to develop such programs including such instructions to carry out the methods on suitably configured network devices. A processor in the computer executes the instructions located on a machine-accessible data communications medium.

The computer-executable instructions may be written in a computer programming language or may be embodied in firmware logic. If written in a programming language conforming to a recognized standard, such instructions can be executed on a variety of hardware platforms and for interfacing to a variety of operating systems.

It will be appreciated that a variety of programming languages may be used to implement the dynamic load balancing system as described herein. Furthermore, it is common in the art to speak of software, in one form or another (e.g., program, procedure, process, application . . . ), as taking an action or causing a result. Such expressions are merely a shorthand way of saying that execution of the software by a network device causes the processor of the computer to perform an action or a produce a result.

Similarly, a machine-accessible data communications medium as used herein includes any mechanism that provides (i.e., stores and/or transmits) information in a form readable by a machine (e.g., a computer). For example, a machine-accessible medium includes read only memory (ROM); random access memory (RAM); magnetic disk storage media; optical storage media; flash memory devices; electrical, optical, acoustical or other form of propagated signals (e.g., carrier waves, infrared signals, digital signals); etc.

FIG. 4A is a flowchart that illustrates one embodiment of how the dynamic load balancing system operates in a host. The host processes the router advertisement message in block 410. If a new source address prefix is identified in decision block 420, the new prefix is added to a prefix table 426 in block 424. Any load information associated with the new prefix that is contained in the router advertisement message is also stored in the prefix table 426. A new source address prefix may not be identified in decision block 420. In this case, the prefix table 426 may be updated in block 422 with any load information associated with an existing source address prefix.

FIG. 4B shows how the host selects a source address prefix. The host processes a data send request in block 428. The host queries the prefix table 426 in block 430 and selects a prefix according to the associated load information. For example, the host may select a source address prefix according to load level information indicating delivery speed, available bandwidth, CPU utilization, number of hops, or other system parameters. Source address prefix selection may be dynamically adjusted according to a variety of factors including the host, the transmitting application, and/or the type of data the host is intending to transmit.

Additional factors may also be considered during the source address prefix selection process, such as the shortest hop, closest geographic exit router, priority of data, quality of service requested, current router bandwidth usage, number of incoming or outgoing connections, type of sessions, number of open connections, number of sessions, and CPU utilization. The host selects a source address prefix from the prefix table 426 and then sends data using the selected source address in block 434.

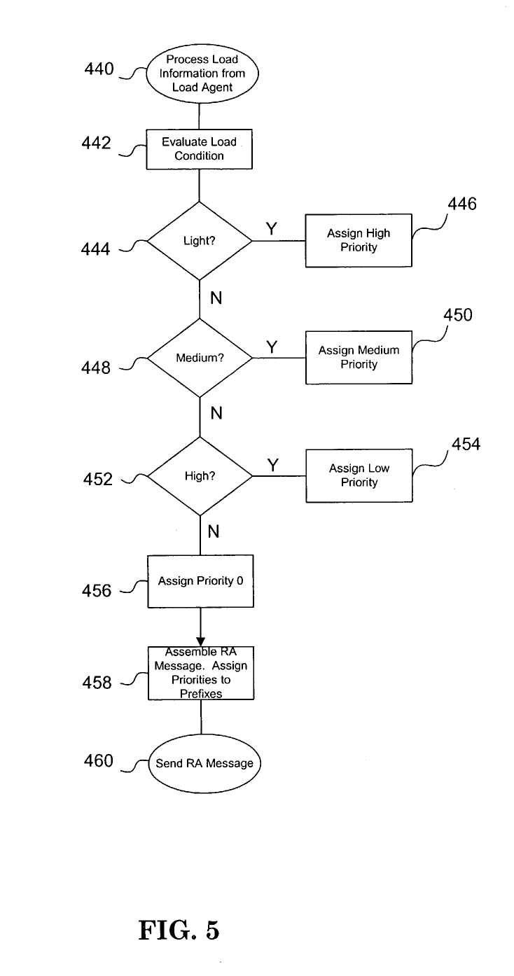

FIG. 5 is a flowchart showing how the site exit router 150 (FIG. 1) assigns priority values based on load information. The site exist router or the gateway exit device requests load information from the load agent or receives unsolicited load information in block 440. The exit router evaluates the load condition associated with the load information in block 442. If the load information is categorized as light in decision block 444, a high priority value is assigned to the source address prefix in block 446.

If the load information is categorized as medium in decision block 448, a medium priority value is assigned to the source address prefix in block 450. If the load information is categorized as heavy in decision block 452, a low priority value is assigned to the source address prefix in block 454. Otherwise, the exit router assigns a zero priority value to the source address prefix in block 456.

Other prioritization parameters used in assigning priority values may include distance to router, size of data transfer, type of data, connection quantity information, bandwidth usage information, open connections information, CPU utilization, and session type information.

Connection quantity information may include shortest hop, closest relative geographic exit router, number of dropped packets, number of redirected packets, number of packets delivered on time, other delivery factors, number of incoming or outgoing connections, number of sessions, priority of data and quality of service requested. Bandwidth usage information may include available bandwidth, average and actual bandwidth usage. Open connections information may include number of open connections and number of available connections.

The source address prefixes may be dynamically prioritized for each data transmission. This allows the requesting host 110-114 to select the best exit router for transmitting packets. The exit router assembles a router advertisement message in block 458 that assigns the priority values to the source address prefixes. The site exit router then sends the router advertisement message in block 460.

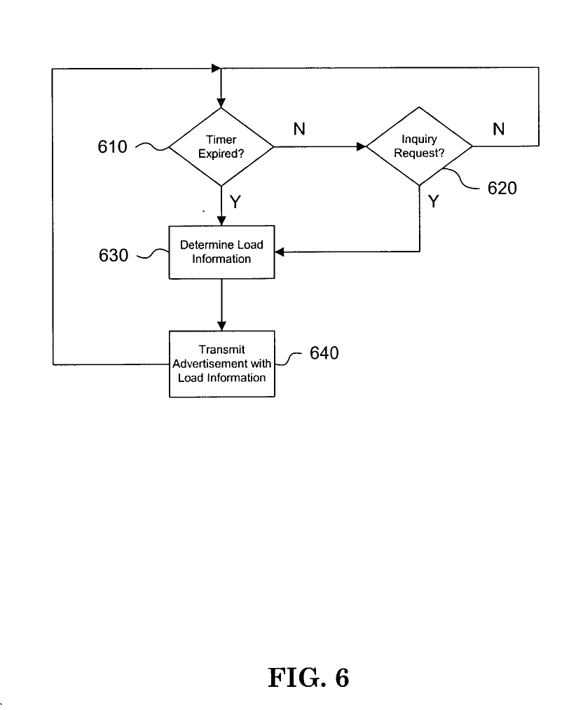

FIG. 6 is a flowchart of a dynamic load balancing process on a network processing device such as an exit router. The load balancing process waits for a periodic timer to expire in query block 610. Upon expiration of the timer, the load information is determined in block 630 for the network processing device. Alternatively, an inquiry request, such as a router solicitation message, may be received prior to the expiration of the periodic timer in query block 620. The inquiry request causes block 630 to determine the load information for the network processing device.

Once the load information is collected, a router advertisement message is transmitted, such as a router advertisement message, containing the load information in block 640. In one embodiment, the load information is transmitted using a multicast address if the advertisement is sent periodically. If the advertisement was generated in response to an inquiry request, the advertisement is sent using the unicast source address of the inquiry request.

A site exit router or gateway device may provide a preliminary indicator that categorizes the load information in a reserved field of the transmitted advertisement message. The site exit router may also transmit the advertisement with the load information to a third party agent to analyze and prioritize the load information.

The present invention may be embodied in other specific forms without departing from its spirit or essential characteristics. The described embodiments are to be considered in all respects only as illustrative instead of restrictive or limiting. Therefore, the scope of the invention is indicated by the appended claims rather than by the foregoing description. All changes, modifications, and alterations that come within the meaning, spirit, and range of equivalency of the claims are to be embraced as being within the scope of the appended claims.

What is claimed is:

1. A method comprising:
receiving source address prefixes at a host having associated load information;
selecting one of the source addresses according to the load information; and
sending packets to an exist router or gateway according to the selected source address.

2. The method of claim 1 including sending an inquiry request that initiates sending the source address prefixes and associated load information.

3. The method of claim 1 including selecting one of the source address prefixes having load information indicating a best access availability.

4. The method of claim 1 including receiving load information including any one of connection quantity information, bandwidth usage information, open connections information, connection quality information, Central Processing Unit (CPU) utilization, or session type information.

5. The method of claim 1 including receiving the source address prefixes and associated load information in a router advertisement message.

6. The method of claim 5 including sending a router solicitation message to request the router advertisement message.

7. The method of claim 5 including receiving the load information in a preexisting field of the router advertisement message.

8. The method of claim 1 including sending packets using the selected source address prefix using Internet Protocol version 6 (IPv6).

9. The method of claim 1 including:
storing the source address prefixes and associated load information in a table;
prioritizing the source address prefixes according to the associated load information; and
selecting the source address with a highest priority in the table.

10. A system comprising:
one or more networking devices configured to detect and send load information;
one or more site exit routers or gateway devices configured to collect the load information and send out the collected load information with associated address prefixes; and
a host configured to receive the load information and associated address prefixes and select one of the source address prefixes according to the associated load information.

11. The system in claim 10 including at least one of the site exit routers or gateway devices configured to send local load information to the host.

12. The system in claim 11 wherein the host is configured to send data through one of the site exit routers or gateway devices having load information with a highest priority.

13. The system in claim 10 wherein the site exit routers or gateway devices are configured to establish multiple communication channels with an Internet Service Provider network and send load information to the host associated with the multiple communication channels.

14. The system in claim 10 wherein the site exit routers or gateway devices are configured to automatically send advertisement messages to the host that include the load information.

15. The system in claim 14 wherein the host is configured to send solicitation messages to the site exit routers or gateway devices requesting the advertisement messages.

16. A network device comprising:
a processor configured to determine load information associated with different network processing devices and send the load information along with address prefixes associated with the different network processing devices to a host system for enabling the host system to select one of the address prefixes according to the load information.

17. The network device of claim 16 wherein the processor generates an address list that includes the load information for the different network processing devices.

18. The network device of claim 16 wherein the processor operates in an exit router or gateway.

19. The network device of claim 16 wherein the loading information includes a number of connections, bandwidth usage, number of available connections, connection quality, Central Processing Unit (CPU) utilization, or session types for the network servers.

20. The network device of claim 16 wherein the processor is configured to send router advertisement messages containing the operational status information and associated addresses.

21. The network device of claim 20 wherein the processor is configured to send router advertisement messages with updated operational status information upon receiving router solicitation messages.

22. The network device of claim 16 including sending the operational status information using Internet Protocol version 6 (IPv6).

23. An article comprising a machine-accessible medium having associated data that, when accessed, results in the following:
receiving address prefixes that include associated load information;
selecting one of the address prefixes according to the associated load information;
deriving a source address using the selected address prefix; and
transmitting data using the source address.

24. The machine-accessible medium of claim 23 including prioritizing the address prefixes according to the associated load information.

25. The machine-accessible medium of claim 23 including receiving the address prefixes and associated load information from router advertisement messages.
